(19) United States
(12) Patent Application Publication
(10) Pub. No.: US 2009/0289873 A1
(43) Pub. Date: Nov. 26, 2009

(54) OBJECT DIRECTION INDICATION THROUGH THE USE OF MULTIPLE ANTENNA BEAMS

(76) Inventors: ROBERT SCHILLING, Londonderry, NH (US); Matthew Lannon, Dracut, MA (US)

Correspondence Address: Jaekle Fleischmann & Mugel, LLP, 12 Fountain Plaza, Buffalo, NY, 14202-2292, US

(21) Appl. No.: 12/340,589

(22) Filed: Dec. 19, 2008

Related U.S. Application Data
(60) Provisional application No. 61/008,333, filed on Dec. 19, 2007.

(51) Int. Cl. H01Q 21/00

(52) U.S. Cl. 343/893

(57) ABSTRACT

An arrangement of RFID antennas, comprises a first antenna having a beam centered at a first angle right of a center point and a second antenna having a beam centered at a second angle left of the center point, where the two beams being narrower than 70 degrees. This arrangement of RFID antennas enables division of the azimuth read zone of a reader into two or more zones which can provide a highly reliable indication of direction from the processing of RF tag reads.

### FIELD OF INVENTION

The present invention relates generally to object direction determination with RFID gateways. More particularly, the present invention relates to antenna positioning within RFID gateways for providing data so that a direction of an object with an RFID tag can be accurately determined.

### BACKGROUND

Ultra-High Frequency RFID gateways (e.g., stand-alone portals and a wall mounted devices) can be employed for numerous applications including object tracking and inventory monitoring.

Within various retail operations, RFID gateways can be placed at strategic locations within a retail store. For example, RFID gateways can be employed at dock doors where merchandise is offloaded from delivery trucks into the back room of the store. As items with associated RFID tags are moved through the dock doors, a gateway located on each side of the door reads the RFID tags on the associated with the items. In this type of operation at the one can assume that the direction of the merchandise is into the store. However, in another example, gateways could also be stationed at the back doors to the sales floor of an establishment. As merchandise (and RFID) tags) passes through the door, the gateways at the doors read the UHF tags on the objects. At this read point however, it is possible that tagged items (e.g., boxes that contained merchandise) on the sales floor, come back through the door before being processed (e.g., thrown in the compactor and balers). When gateways are stationed at this location, there is a need to know whether a given tag is being read going onto the sales floor or returning from the sales floor.

The Federal Communications Commission (FCC) currently limits the strength of the radiated field used by tag readers to detect UHF RFID tags. Specifically no more than 30 dBm is permitted into an antenna with a gain of no more than 6 dBil (+36 dBm EIRP). Accordingly, conventional UHF RFID antennas that are used to detect tags comprise air dielectric patch elements with circular polarization (CP). The circular polarization allows the tag reader to read the linearly polarized tags regardless of their orientation in space. To date, these air dielectric circular polarization antennas have a fairly broad beam in both the azimuth and elevation planes. Beamwidths of approximately 70° are typical.

Multiple efforts have been undertaken to add directionality (the ability to determine, via the RF signal, the direction that a tag (or set of tags) is traveling as it passes through a portal read area). To date, some experimentation with regard to directionality has included utilizing two conventional antennas canted away from each other by 20° to 40° (10° to 20° left and right of normal) as illustrated in FIGS. 1A and 1B, for example. FIG. 1A illustrates antennas in a side by side fashion and FIG. 1B illustrates tags in a stacked fashion. Referring to FIG. 1A, as a tag passes through this portal from left to right, it is read first by the left antenna 120, then by both antennas 110 and 120 in an overlapping field, then by the right antenna 110. To obtain tag directionality information, the readings are next mapped in time to provide a sense of directional movement. Received Signal Strength Indication (RSSI) can be use to compare signal strength in time and a direction of movement established. However, a gateway employing this configuration does not provide enough of a read/no-read discrimination in the primary field of view because the tag is read by both antennas across most of the usable read zone. Moreover, if RSSI is implemented, multiple tag reads can be used to incorrectly boost the confidence level in the direction of a single or few tags. However, better tag read/no-read discrimination is needed in the case of multiple tags passing through the portal to provide directionality with a higher level of confidence.

### SUMMARY

In accordance with one exemplary embodiment of the present invention, an RFID antenna solution is provided. The solution comprises a first antenna element having a beam centered at a first angle right of a center point and a second antenna element having a beam centered at a second angle left of the center point. The two beam are narrower than 70 degrees.

### DRAWINGS

The invention will now be described by way of example with reference to the accompanying drawings in which:

FIG. 1A is a top view of the application of conventional antennas as described, arrayed side-by-side

FIG. 1B is a top view of the application of conventional antennas described arrayed one on top of the other;

FIG. 2 is a top view of the application of narrow beam antennas in accordance with an exemplary embodiment of the present invention; and

FIG. 3 is a block diagram illustration of a portal gateway that includes the antenna configuration in accordance with the present invention.

### DETAILED DESCRIPTION

For simplicity and ease of explanation, the invention will be described herein in connection with various embodiments thereof. Those skilled in the art will recognize, however, that the features and advantages of the various embodiments may be implemented in a variety of configurations. It is to be understood, therefore, that the embodiments described herein are presented by way of illustration, not of limitation.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. Additionally, the arrangement and configuration of the various components described herein may be modified or changed, for example, replacing certain components with other components or changing the order or relative positions of the components.

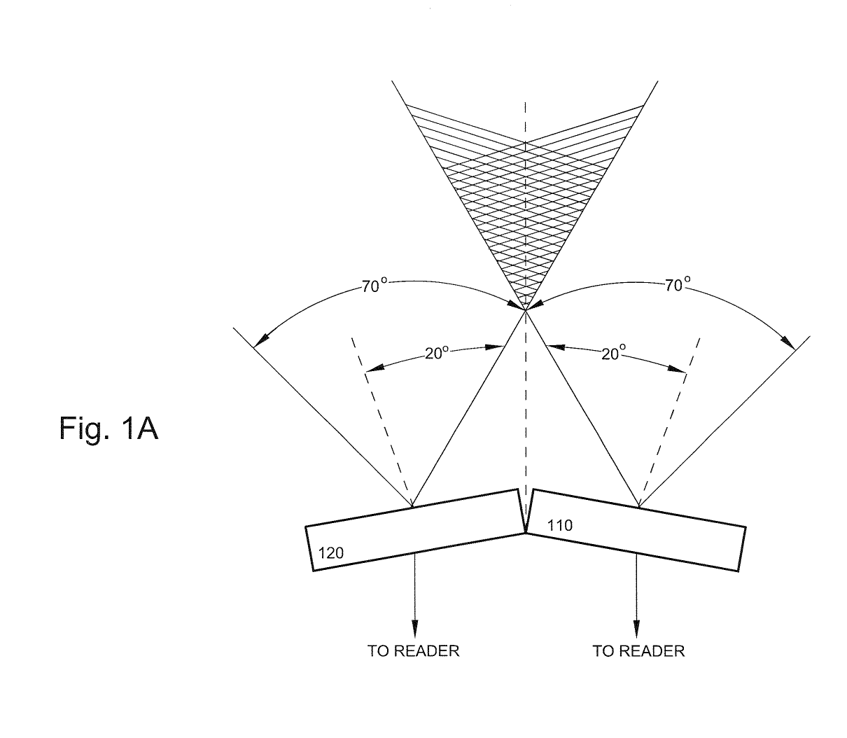

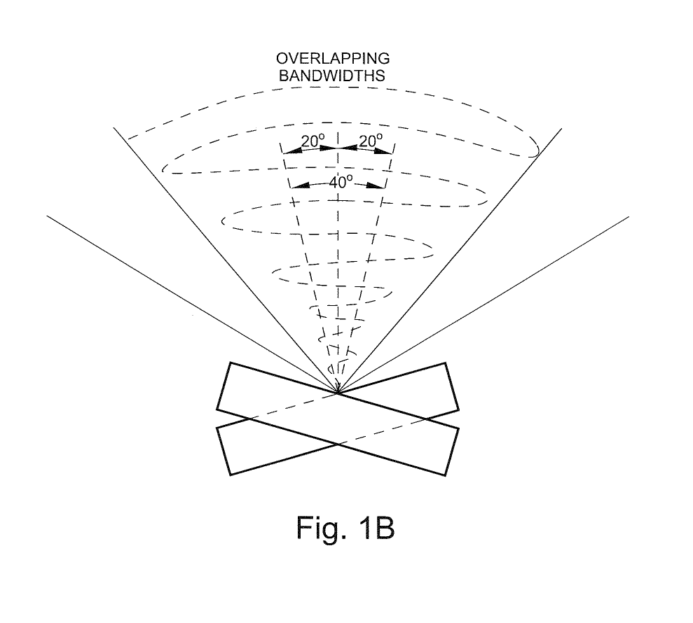

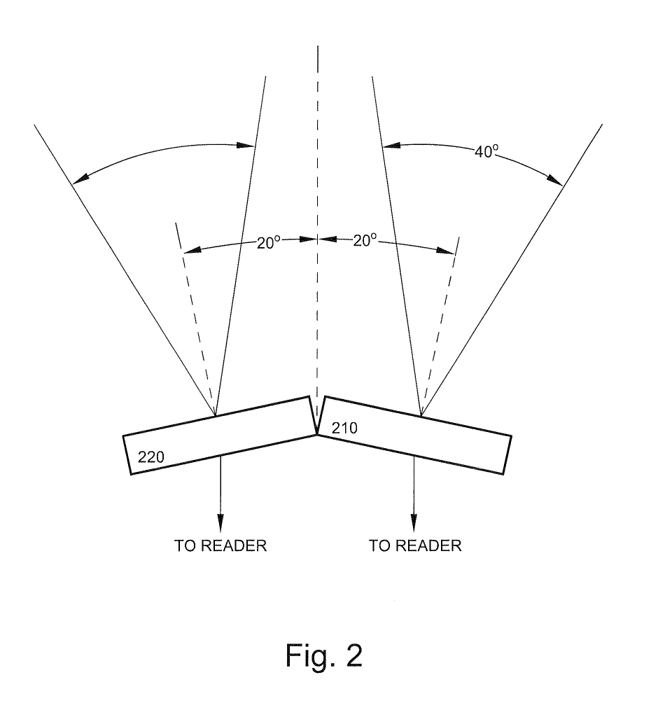

In accordance with an exemplary embodiment of the present invention, FIG. 2 illustrates a top view of an antenna system 200 including two narrow beam antennas 210, 220 that can be employed within RFID gateways. The antennas in FIG. 2 are canted 20° off boresight and, in accordance with the present invention, have a beamwidth of 40°, thereby significantly reducing the overlap of coverage with the two antennas 210, 220 shown in FIG. 2. Specifically, the antenna system of the present invention includes a first antenna element 210 and a second antenna element 220 positioned in a side by side relationship. While the embodiment shown in FIG. 2 shows a set of two narrow beam antennas additional antennas could be employed in order to dissect the azimuth into additional sectors. Also, while the arrangement of the antennas 200 is shown in a side-by-side positioning, the arrangement 200 could also be employed in a stacked configuration, in a manner similar to the standard wide-beam antenna application shown in FIG. 1B.

The employment of two antennas 210, 220 enables two separate beams to identify RFID tags. As illustrated in FIG. 2, the individual antennas can be modified so that the peaks of the two beams are angled to the left and right of center. For example, the beams can be angled from 10° to 20° from center (boresight). Further, an in accordance with an exemplary embodiment of the present invention, each antenna 210, 220 can be modified to emit a narrower beam (e.g., 40°) than conventional antenna azimuth beamwidth (e.g., 70°). By modifying the antennas in this fashion, the same or better net azimuth coverage is provided than that of the single beam solution in order to identify RFID tags. However, the multiple beam embodiment shown in FIG. 2 provides a unique ability to provide data to enable positional discrimination of tag direction.

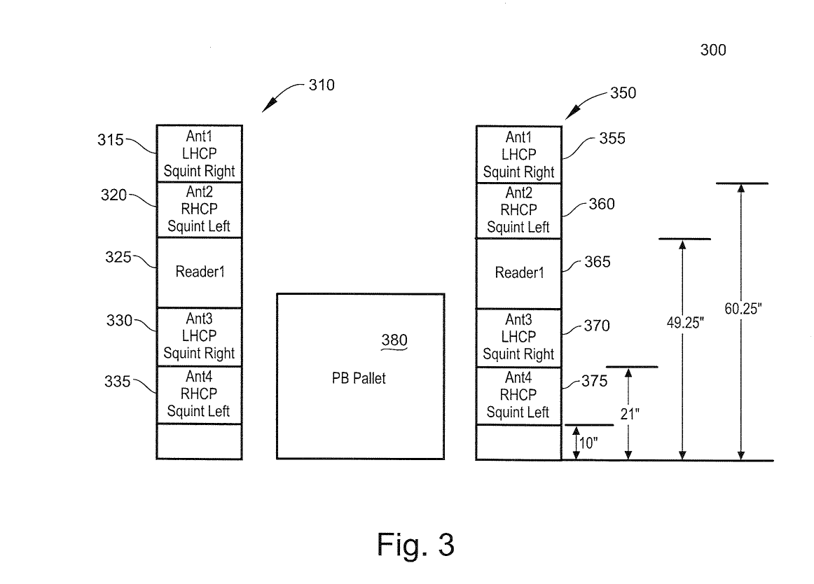

For example, for an RFID tag (associated with a product) moving from the left to the right through the gateway, the antenna 220 whose beam is focused to the left will allow identification of the tag before it can be read by the antenna 210 whose beam is squinted to the right. Further, the narrower beam of each antenna narrows the reading range and thereby reduces ability to read a tag located outside of its optimal reading zone. This enables reader (shown in FIG. 3) to process tag reads associated with a given time and enable determination of the direction of the RFID tag traveling through the gateway in a more efficient manner.

Focusing on the antennas themselves, two items are key to successful directionality determination. The first, as discussed above, is that the antenna needs to have a narrower than conventional azimuth beamwidth, (e.g., 40° vs 70°). The second is that the beam is be focused 10°-20° off center with one antenna 210 angled to the right and the other antenna 220 angled to the left, their two beams then focused 20°-40° apart.

Several design techniques are available to reduce the azimuth beamwidth such as selective location of reflectors and directors, or the use of an azimuthal array of antenna elements

The beam of the antenna can be focused off axis either mechanically (as shown in FIG. 2), electrically, or a combination of both. Simply pointing the antenna at 10° to 20° off will result in the desired beam location. However, the tilting of the antenna elements could result in spacing issues. For wall mounted RFID gateways, the result of the mechanically tilted antenna elements could result in larger wall space taken or protrusion from the wall. In portal applications, the purely mechanically tilted elements may not allow the antenna to be mounted. By providing an electrical phase differential between the antenna elements in an antenna, the beam can be squinted off axis. This would allow the antenna 200 to sit flush against the wall or fit into an existing portal. However, squinting the beam electrically does have limitations. The further the squint angle, the larger the reduction in peak gain and the higher the level of the sidelobe that is produced. In cases where a large squint angle is desired, a combination of mechanical and electrical squint may provide the best result.

The positioning of the antennas as described provides for about 10 dB of discrimination from side to side and improves the confidence level of directionality beyond what can be done with conventional antennas having approximately 70 degrees of beamwidth canted at 15 degrees. When employing additional antenna elements with each providing a narrower bandwidth, further resolution and more data to accurately determine an object's direction.

The use of two or more antenna elements associated with an RFID reader, providing more directive in azimuth and having the same elevation beamwidth, does not compromise the ability to read objects from a single position. Furthermore, the narrower azimuth beam of the antennas provides an increase in the gain of the antenna. By utilizing a transmit power reduction from the reader to maintain compliance with the Effective Isotropic Radiated Power (EIRP) specification of +36 dBm per the FCC, the receive gain of the antenna is not reduced and farther tag read distance is obtained with a reduction in transmit power.

FIG. 3 illustrates the antenna system of FIG. 2 implemented in a RFID portal system 300 in accordance with the present invention. The RFID system portal system includes a first portal 310 and a second portal 350. The first portal 310 includes a first left hand circular polarization antenna 315 squinted (or angled) to the right, a first right hand circular polarization antenna 320 squinted (or angled) to the left, a reader 325, a second left hand circular polarization antenna 330 squinted to the right and a second right hand circular polarization antenna 335 squinted to the left. The second portal 350 includes a first left hand circular polarization antenna 355 squinted (or angled) to the right, a first right hand circular polarization antenna 360 squinted (or angled) to the left, a reader 365, a second left hand circular polarization antenna 370 squinted to the right and a second right hand circular polarization antenna 375 squinted to the left. The embodiment described in FIG. 3 would be used if numerous RFID tags would move through the reader's detection area in both a low and high vertical height (e.g., double stacked or double height pallets).

While the embodiment provided in FIG. 3 shows to antennas located on the top of the portals 310, 350, another embodiment could employ a single antenna on the top and two on the bottom (as described above) if, for example, the RFID tags would be closer to the ground (e.g., single height pallets 380).

Through RF mapping of the read zone of the portals 310, 350, the standard read zone for a RFID tag can be split. Using two or more antennas, vertically stacked, with improved azimuth directionality to cover a full 70° beam of read provides significantly improved RE read discrimination. Tag reads performed by the tag reader 325, 365 will be maintained in the 95% or above and a very specific and confident solution to directionality can be processed by using either a time method (read first by left antenna, second by both antennas, third by right antenna), or an RSSI method showing a higher level of position by tag signal strength versus time.

The time method involves the reader and associated antenna configuration, as shown for example in FIGS. 2-3, reading an RFID tag moving from one side to the other and reading the RFID tag a multiple number of times. The RFID tag is first read from a first antenna element while not reading it form the other antenna element. Next then in time a number of reads from both antennas, and finally in time reading the tag from the side that did not read it first and not reading it from the one that did. This clearly paints a map in time of the directionality. RSSI is a method by which the reader can measure the relative signal strength (Relative Signal Strength Indication) of a tag, Processing this parameter will show a clear indication of the tag watch it start weak on one side, increase there, then show in both and the patter mirror after that.

In accordance with the present invention the division of the azimuth read zone of a reader into two or more zones through the use of directional antennas can provide a highly reliable indication of direction from the processing of RF tag reads.

1. A arrangement of RFID antennas, comprising:
a first antenna element having a beam centered at a first angle right of a center point; and
a second antenna element having a beam centered at a second angle left of the center point, wherein the two beams being narrower than 70°.

2. The system of claim 1 wherein the two antennas are arrayed one on top of the other

3. The system of claim 1 wherein the two antennas are arrayed side by side.

4. The system of claim 1 wherein the antennas are circularly polarized of the same or opposite sense.

5. The system of claim 1 where the antennas are linearly polarized of any arbitrary sense.

6. The system of claim 1 where the antennas are of any arbitrary polarization.
